(19) United States
(12) Patent Application Publication
(10) Pub. No.: US 2004/0006519 A1
(43) Pub. Date: Jan. 8, 2004

(54) System and method for merchandising certified autographs via the internet

(76) Inventor: Dong-Su Lee, Kwagokl-dond (KR)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/343,386

(22) PCT Filed: Jul. 30, 2001
(86) PCT No.: PCT/KR01/01296

(30) Foreign Application Priority Data
Jul. 31, 2000 (KR) 44409/2000

(51) Int. Cl. G06F 17/60

(52) U.S. Cl. 705/26

(57) ABSTRACT

Disclosed herein is a system and method for merchandising certified autographs via the Internet. The autograph issuing system is mainly comprised of client and server systems (100 and 200). The client system (100) is comprised of a web browser (101) for displaying web pages, client identification information (102) such as a member ID, a password or the like, and Internet connection means. The server system (200) is connected to the client system (100) via the Internet. The server system (200) is comprised of a plurality of web pages (201) including an autograph order form, a server engine (202) for selecting and transmitting appropriate web pages in response to hyper text transfer protocol information, a variety of information input forms (203) transferable when the client identification information (102) is requested by the client system (100), and a plurality of databases (204 to 207) for combining and retrieving various information.

### BACKGROUND OF THE INVENTION

1. Field of the Invention

In a system and method for merchandising certified autographs via the Internet of the present invention, a service provider produces autographs directly signed on special paper by famous entertainers or celebrities to prevent forgery, merchandises a limited number of autographs to a plurality of service users via the Internet, thus assigning monetary worth to the autographs, and allowing the worth and merchantability of the autographs to be derived due to the certified signature.

2. Description of the Prior Art

The present invention relates generally to a system and method for merchandising certified autographs of famous entertainers or celebrities via the Internet, and more particularly to a system and method, in which service users connected to a Web server of a service provider via the Internet order autographs of famous persons on offer, and the service provider produces the ordered autographs using a special paper to prevent forgery, charges the service users for the autographs, and delivers the autographs to the service users, thereby ensuring the worth and merchantability of the autographs of famous persons to be printed on fine printing paper, like a bill, to be derived.

As well known to those skilled in the art, the Internet is originated from American Public Power Association Network (APPANET) formed for an effective information share for the purpose of military applications by Defense Advanced Research Projects Agency (DARPA). As the Internet has gradually developed, it has been applied to various uses such as communication between computers including email, news groups, Web services, and an information collection, or means for publicity of companies or persons in all parts of the world.

As the Internet has deviated from initial specific uses and the number of Internet users has rapidly increased, commercialization through the Internet has spread with high speed and various types of Internet businesses have been proposed and used.

Internet business is classified into three types: information provider service (IP), network service and electronic commerce (EC). The IP service is a service for charging a service user a corresponding service fee and providing a plurality of required information to the service user. The network service is a service for enabling a plurality of users to play online games through the network. The electronic commerce is a service for enabling goods or services to be merchandised between a company and a person, or between companies via the network.

Among the Internet services, electronic commerce by computer terminals is recently most popular, and many items related to electronic commerce have been successively developed.

On the other hand, the autographs of famous entertainers or celebrities are not yet publicly merchandised using the electronic commerce online through the Internet or offline. Further, conventional autographs are only used as objects to be collected according to personal preference.

Such autographs may be obtained by directly meeting the famous entertainers or celebrities, or through separate personal relations. In this case, the number of famous persons providing autographs is generally limited in comparison with that of the persons seeking their autographs, such that the conventional autographs are disadvantageous in that it takes much more time and effort to obtain the autographs.

Further, the autograph collectors (autograph seekers) do not prepare a separate signature paper for receiving the autographs, and simply receive an autograph on an ordinary piece of paper or some clothing parts. Accordingly, as time passes, the paper or the clothes may be discolored or worn-out, and therefore problems in keeping the autograph preserved occur.

Moreover, there may be a large number of autographs available to the public for a short period of time, thus deteriorating worth of the autograph, inducing forgery, and thus decreasing its monetary worth.

### SUMMARY OF THE INVENTION

Accordingly, the present invention has been made keeping in mind the above problems occurring in the prior art, and an object of the present invention is to provide a system and method for merchandising certified autographs via the Internet, which is accomplished by a service provider for operating and managing a Web server connected to the Internet and a plurality of databases for storing offer information of autographs and a variety of autograph forms, a service user for accessing the Web server of the service provider, ordering autographs on offer, and paying a fee for an ordered autograph, and an autograph provider for signing an autograph to be distributed by the service provider and collecting a commission.

In order to accomplish the above object, the present invention a system for merchandising certified autographs via the Internet, comprising a client system (100) comprised of a web browser (101) for displaying various web pages, client identification information (102) such as a member ID, a password or the like, and Internet connection means; and a server system (200) connected to the client system (100) via the Internet, and comprised of a plurality of web pages (201) including an autograph order form, a server engine (202) for selecting and transmitting appropriate web pages in response to hyper text transfer protocol information requested by the client system (100), a variety of information input forms (203) transferable in various formats when the client system (100) is connected to the server system (200) and then the client identification information (102) is requested by the client system (100), and a plurality of databases (204 to 207) for combining and retrieving various information processed by the drive of the server engine 202.

Preferably, the service provider secures a plurality of autographs from famous entertainers or celebrities, offers a limited quantity of autographs to service users connected to the Web server, distributes the offered autographs to the service users by a fair lottery or order of arrival, and after confirming payment of an allotted service user, delivers a corresponding autograph to the allotted user by mail or home delivery service.

At this time, only after the service user accesses the Web server of the service provider and signs up as a member, the service user may meet the requirement for applying for an autograph offer, and may apply for an autograph offer, confirm an allotting result, and alter user conditions for the offer through a variety of Web pages provided by the Web server of the service provider.

The Web server of the service provider stores the personal information of service users who access the Web server through the Internet and sign up on the Web server as a member through a member information input form on a Web page in a member information database. Further, the server system assigns a specific client identification to each client system of the service users through the Internet.

The server system stores specific purchaser order information from various potential service users in an offer autograph database, and the specific purchaser order information may be collected from autograph order information previously performed by the service users.

When the service user desires to purchase autographs at the server system of the service provider, the service user transmits a client identification (ID) and request information for requesting a description or a photograph of an autograph to purchase through the client system to the service provider.

Then, the server system of the service provider confirms the client identification information from the service user, and determines whether the service user can apply for offering autographs if the service user is confirmed as a member.

If the user can apply for offering autographs, the server system transmits the required information together with instructions on to order autographs in the form of a Web page to the Web browser of the service user computer.

As described above, the service user reads various autograph information stored in the database by the information transmitted to the Web browser, and orders or offers a specific autograph. Then, the client system of the service user transmits autograph order information corresponding to the ordered autograph to the server system.

Thereby, the server system of the service provider completes an order by adding specific order information written by the user, in other words, the specific autograph and quantity thereof, a recipient, and the autograph order information, to the client identification.

According to the system and method for merchandising certified autographs via the Internet of the present invention, the service provider produces autographs of famous entertainers or celebrities on special papers to prevent forgery, and offers only limited number of autographs for registered service users via the Internet, thus assigning monetary worth to the autographs according to the quality and demand of the autographs.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 5 are views showing the screens of Web pages according to a preferred embodiment of the present invention,

FIG. 1 is a view showing a summarized screen for displaying offerable autograph information,

FIG. 2 is a view showing an offer confirmation screen for displaying offer information of the service users,

FIG. 3 is a view showing a screen of autograph forms for displaying offer applied autographs forms,

FIG. 4 is a view showing a screen of an offer application form for a service user of this invention, and

FIG. 5 is a view showing a screen of an offer order information explanation displayed when the offer application is completed;

FIG. 6 is a block diagram of a system according to a preferred embodiment of the present invention;

FIG. 7 is a flowchart of a normal offer order process of this invention;

FIG. 8 is a flowchart of a process of allotting and delivering autographs after all offers order is completed;

FIG. 9 is a flowchart of a cooperative order process of this invention; and

FIG. 10 is a flowchart of a process of delivering a cooperative ordered autograph.

### ESCRIPTION OF THE PREFERRED EMBODIMENTS

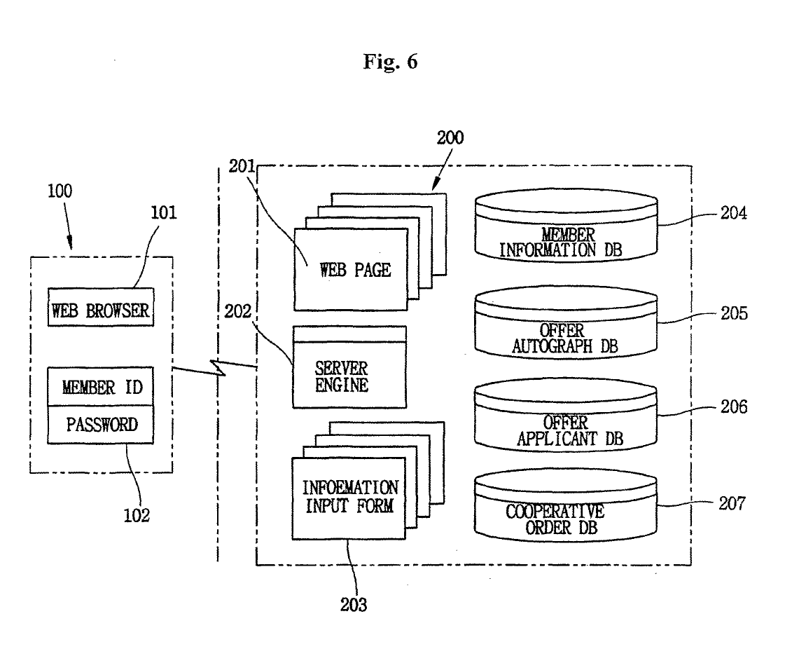

FIG. 6 is a block diagram showing the construction of a system according to the present invention. Referring to FIG. 6, the system for merchandising certified autographs via the Internet comprises a client system 100 of a service user, and a server system 200 of a service provider. The client system 100 includes a Web browser 101 and user's identification information 102. The server system 200 interfacing with the client system 100 through the Internet includes a plurality of Web pages 201, a server engine 202, a variety of information input forms 203, and a plurality of databases 204 to 207.

The Web browser 101 of the client system 100 displays a variety of Web pages 201 received from the server system 200, and the user's identification information 102 consists of a member ID and a password of a service user authenticated by the server system 200.

Further, the server engine 202 of the server system 200 receives a Hyper Text Transfer Protocol (HTTP) request for accessing the Web pages 201 of the server system 200, which are discriminated according to URL information, from the client system 100, and displays a variety of Web pages 201 through each Web browser 101 of a plurality of client systems 100 connected to the server system 200.

Further, a variety of information input forms 203 of the server system 200 include fields for inputting a member ID and a password, which are inputted and stored through the Web browser 101 of the client system 100 by the service user. In addition, the information input forms 203 require inputting basic information such as a name, an age, and a job of the service user, and etc. Whenever, the client identification information 102 authenticated by the server engine 202 is requested, various types of information input forms 203 are displayed on the Web browser 101 of the client system 100.

The databases for combining and retrieving a variety of information by driving of the server engine 202 are comprised of a member information database 204, an offer autograph database 205, an offer applicant database 206, and a cooperative order database 207. The member information database 204 stores basic personal information of the service user and the client identification information 102, when the user accesses the server system 200 and transmits the client identification information 102. The offer autograph database 205 provides and stores autograph information, which are on offer or completed, and are capable of being obtained through a variety of Web pages 201 transmitted to the Web browser 101 of the client system 100. The offer applicant database 206 stores client information that searches the offer autograph database 205 through the server system 200 and orders for offering autographs according to the searched information. The cooperative order database 207 receives cooperative offer orders from the client system 100 according to whether a corresponding autograph is registered, and stores the cooperative order information.

The client system 100 and the server system 200 having the above constructions are connected to each other via the Internet. First, while the client system 100 first communicates with the server system 200, the server system 200 assigns and transmits the client identification information 102 to the client system 100. After that, the client system 100 inserts the client identification information 102 to all messages to be transmitted to the server system 200, and the server system 200 may identify the source of a message received from client system 100.

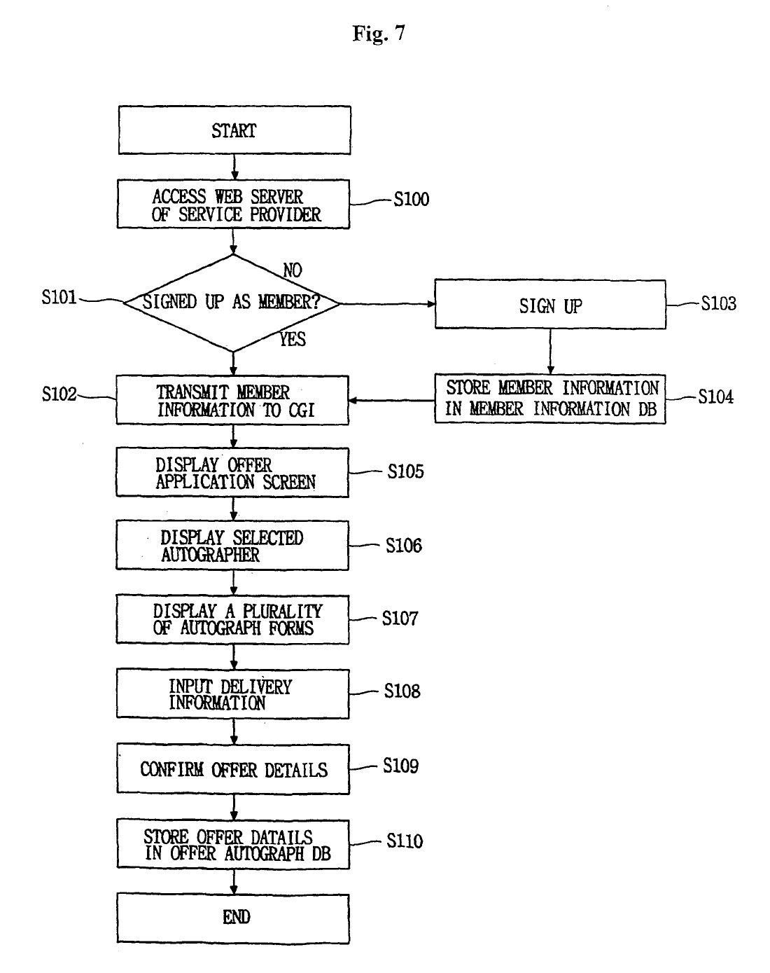

FIG. 7 is a flowchart of an offer order process of this invention. Referring to FIG. 7, in the system and method for merchandising certified autographs via the Internet of this invention, the service user operates the Web browser 101 on a computer terminal having an Internet connecting means, and inputs a URL address on the Web browser 101 in response to the HTTP request of the Web browser. Thereby, the computer terminal of the service user is connected to the Web server of the service provider at step S100, such that the homepage of the service provider is displayed on the Web browser.

At this time, the server system 200 identifies the client identification information 102, which is inputted in a user identification information field in the Web page displayed on the Web browser 101 and transmitted to the service provider, and determines whether the user is signed up as a member at step S101. Then, the identification information 102 authenticated by the server system 200 is transmitted to the CGI program at step S102.

On the other hand, if the client identification information 102 of the user is not authenticated, a signing up procedure is performed by inputting a member ID, a password and basic member information of the user in the information input forms 203 provided by the server system 200 at step S103. Then the user is authenticated by the server system 200, and the user's basic member information is stored in the member information database 204 of the server system 200 at step S104.

After the user is authenticated by the server system 200, the offer application page in which a plurality of offer autograph information are summarized is displayed on the Web browser 101 of the client system 100 at step S105. Personal information of an autographer selected from the offer application page by clicking a mouse is displayed at step S106.

Further, when the autographer information is confirmed by the client system 100 at step S106, the server system 200 transmits a plurality of autograph forms to the Web browser 101 of the client system 100 and displays the autograph forms at step S107. Then, the client system 100 selects a desired autograph form among the autograph forms.

When the client system 100 selects the autograph form, the server system 200 generates a flag instruction for representing that the user is capable of ordering autographs, displays delivery information input form of the information input forms 203, such that the server system 200 requires the client system 100 to input delivery regional information at step S108.

If the regional delivery information inputted to the delivery information input form and the client identification information of the client system 100 are transmitted to the server system 200, such that the user attempts to order the autographs, the server system 200 receives the client identification information again from the client system 100. At this time, when the user is finally identified as an offer applicant, the server system 200 displays offer order details on the Web browser 101 such that the user confirms the offer order details at step S109. Then, the offer order details are stored in the offer autograph database 205 at step S110.

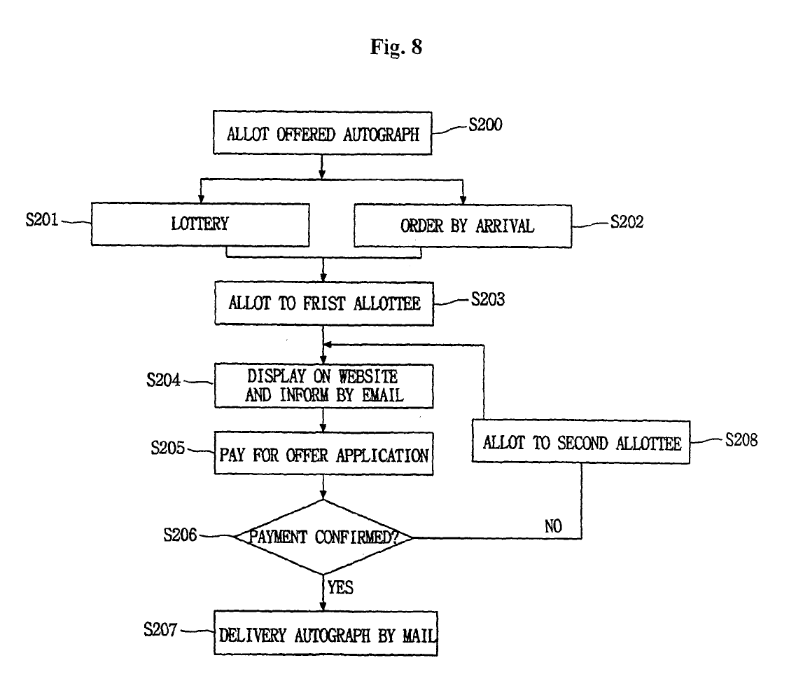

FIG. 8 is a flowchart showing a process of allotting and delivering the autograph after the offer order is completed of this invention. Referring to FIG. 8, in the autographs merchandising system of the present invention, when the autograph offer order is performed by the server system 200 from the client system 100 as shown in FIG. 7, the server system 200 integrates specific order information relating to the client system 100, such as the specific autograph offer order and quantity ordered, or recipient information, and completes the order information.

As described above, the order information from each client system 100 is stored in the offer applicant database 206, and the offered autograph is allotted in response to the offer applicant information at step S200.

The allotment of the offered autograph is accomplished by a lottery at step S201, or by order of arrival at step S202. If an offered quantity of autographs is not reached to an offer predictive quantity, only the offered quantity of autographs are produced.

If the allotment method is decided by lottery or by order of arrival, client information of the client system 100, which selects a corresponding autograph as the first order, is extracted from the offer applicant database 206, such that the client system 100 is primarily selected to be a first allottee at step S203. Then, a list of first allottees is displayed on the Web site through the Web page 201 of the server system 200, which is transmitted to the client system 100, and the allotting result is further informed to the client system 100 through an email at step S204.

At this time, the server system 200 requires the client system 100 to pay a fee corresponding to the quantity of the applied autograph at step S205, and confirms payment of the client system through the service provider's own database or a computer network of banking facilities at step S206.

If the payment of the first allottee is confirmed, the service provider delivers a corresponding autograph to the first allottee (autograph offer winner) according to information obtained by combining the basic member information stored in the member information database 204 and the specific offer order information stored in the offer applicant database 206 by mail or a predetermined delivery means at step S207.

However, at step S206, if payment of the first allottee is not confirmed by a predetermined date, an opportunity for the second order allotment is given to a second allottee at step S208, and then the server system 200 repeats the procedure from the step S204 for displaying and informing the allotting result to remaining steps S205 to S207.

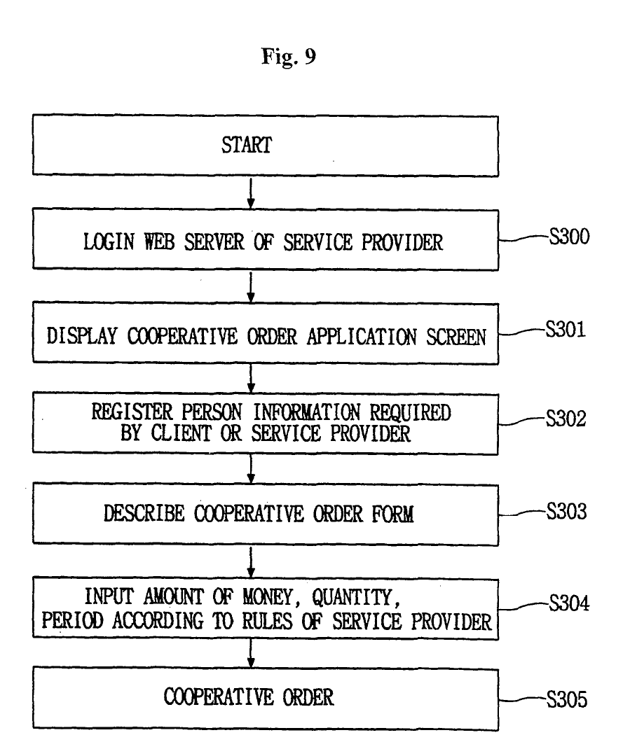

FIG. 9 is a flowchart showing the cooperative order process of this invention. As shown in FIG. 9, a service user operating the client system 100 accesses the server system 200 of the service provider and transmits the client identification information 102 to the server system 200 though the Web browser 101 for performing a login procedure at step S300. At this time, when the service user requires the server system 200 to transmit the Web page 201, the server system 200 extracts the cooperative order application form selected among a plurality of Web pages 201 and displays the cooperative order application form on the Web browser 101 of the client system 100 at step S301.

In this case, the login information can be identified by the client identification first received from the client system 100. In the client system 100 logined according to the offer order process of FIG. 7, the login procedure of the client system 100 into the server system 200 can be omitted.

The service provider registers information of persons, who are provided from the client system 100, or who provide the autograph designated by the service provider, on the cooperative order application form provided on the Web browser 102 by the server system 200 at step S302. Then, the service provider requires the client system 100 to describe the cooperative order form at step S303.

Further, the service provider registers each appropriate price and each order period for the ordered autograph on a predetermined cooperative order state window at step S304, thus completing the cooperative order registration at step S305.

The cooperative order for an autograph is validated and selected as an offered object only when the ordered quantity of the inputted autographs exceeds a predetermined quantity. If the number of cooperative orders is small for a predetermined period of time, the cooperative order can be excluded.

Further, in order to prevent the autograph from recklessly being issued due to a large quantity of orders by a few persons, it is preferable to limit the quantity of an order per person such that a user cannot order the autographs more than a predetermined number of times (for example, three sheets of autograph).

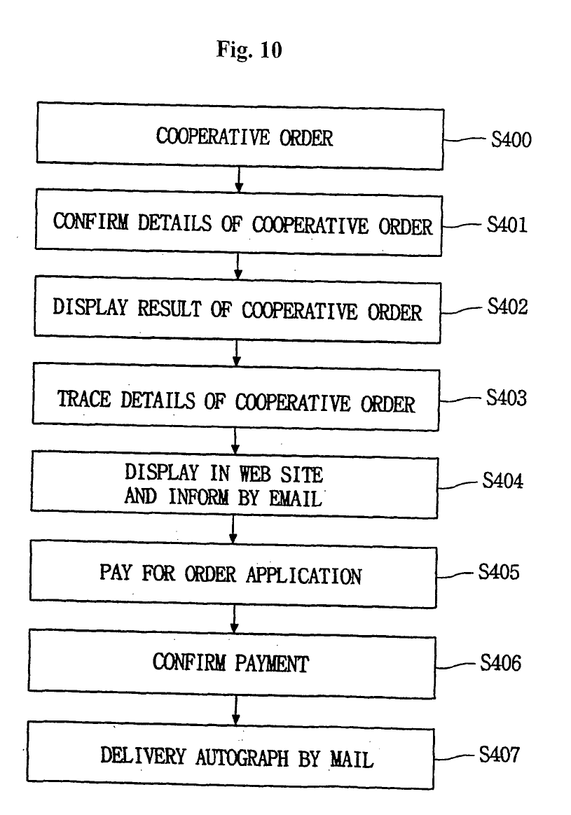

FIG. 10 is a flowchart showing the process of delivering the cooperative ordered autograph of this invention. Referring to FIG. 10, in the cooperative ordered autograph delivering process, the client system 100 applies for the cooperative order autographs according to the login information of each client system 100 at step S400, and confirms details of the cooperative order according to information stored in the cooperative order database 207 at step S401.

In this case, the result of the cooperative order received from the cooperative order database 207 transmitted is displayed on the Web browser 101 of the client system 100 at step S402, and the client system 100 traces the details of cooperative order for autographs at step S403.

The cooperative ordered autograph deliver process is accomplished according to the same sequence as that of the normal autograph delivering process. In other words, when the issue of an autograph according to the cooperative order is decided, each client's identification information 102 is displayed on the Web site of the service provider through the server system 200, and the results are sent to the client system by email service at step S404. If the service user pays a fee for order application at step S405, the server system 200 confirms payment of the user by the computer system at step S406, and then the server system 200 delivers the ordered autograph to the service user at step S407.

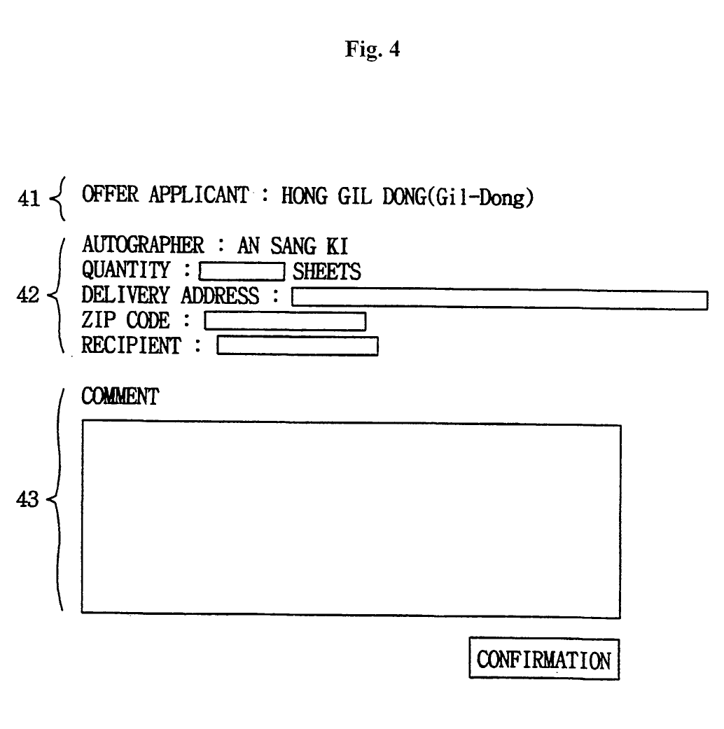

Meanwhile, the autograph merchandising system and method of the present invention enables the service user to confirm and alter the offer application order by the client system 100. The alteration of the offer application order is accomplished by altering the offer conditions on the Web page displaying the offer details, and alteration form of offer application orders displayed on the Web page is made with the same form or similar form as the offer application form shown in FIG. 4.

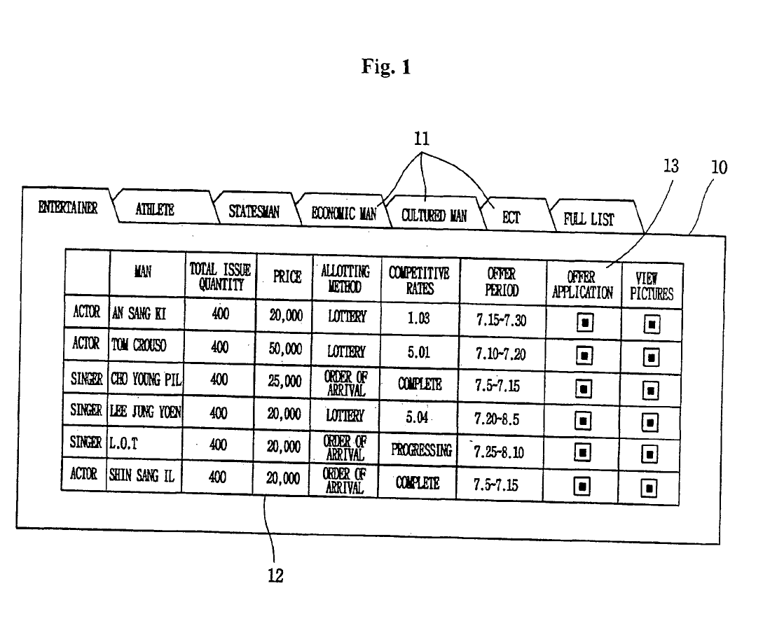

In this case, when the user alters the offer application conditions, it is preferable to disable the user from altering the condition after a designated offer period shown in FIG. 1 elapses.

Further, the service provider separately arranges a merchandising window using an auction and a reverse auction method in order to enable the service users to merchandise autographs distributed on the market between users, and a current price viewing field in order for the service user to view the current price of an issued autograph in a variety of Web pages 201 and a plurality of information input forms 203 of the server system 200, thus enabling each client system 100 to freely merchandise the autographs.

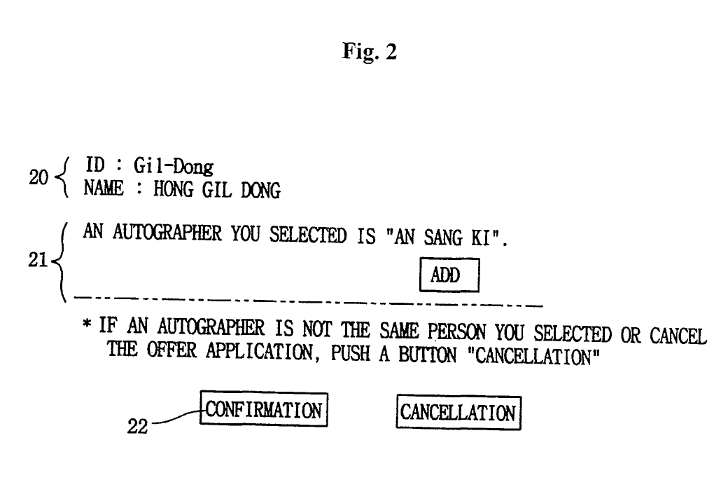

FIGS. 1 to 5 are views showing the screens of Web pages according to a preferred embodiment of the present invention. FIG. 1 is a view showing a summarized screen for displaying offerable autograph information, and FIG. 2 is a view showing a screen of offer confirmation screen for displaying offer information of the service users.

As shown in FIGS. 1 and 2, the Web page of this invention is provided to the service user from the server system in the case that the service user accesses the Web server of the service provider and selects a “view detail” button for an autograph on offer.

According to the embodiment of this invention, the Web page 10 is comprised of an autographer field 11 placed at the upper portion of the Web page 10 and a summarized explanation field 12 represented with a table sectioned into a plurality of blocks.

The autographer field 11 is divided into a variety of classes and jobs such as entertainer, athlete, statesman, economic or cultural personality to be selected by a mouse operation of the service user.

In the summarized explanation field 12, autographs to be offered by the service users are distinguished, and autograph information to be explained are provided. Further, information such as the name of the autographer, total issued quantity, and amount of money for each autograph, an allotment type, etc. are displayed on the summarized explanation field 12, such that the user may confirm a progressing state for each offered autograph at a time.

When the service user clicks the offer application field 13 with respect to a desired autographer in the summarized explanation field 12 using a mouse, the autographer information 21 of FIG. 2 is displayed, and the client identification information 20 of the offer applicant is displayed on the Web browser.

At this time, it is well known in the field that the autographer field 11 and the summarized explanation field 12 of the Web page 10 can be omitted, rearranged or added with various formats.

The client identification information 102 includes client's identification (ID), in other words, recipient of the autograph is changed to another person not the service user, the delivery information can be revised.

Further, if the service user designates a specific recipient, the service user inputs an additional message in the comment input field 43, and the service provider delivers the ordered autograph enclosed with the inputted comment to the recipient.

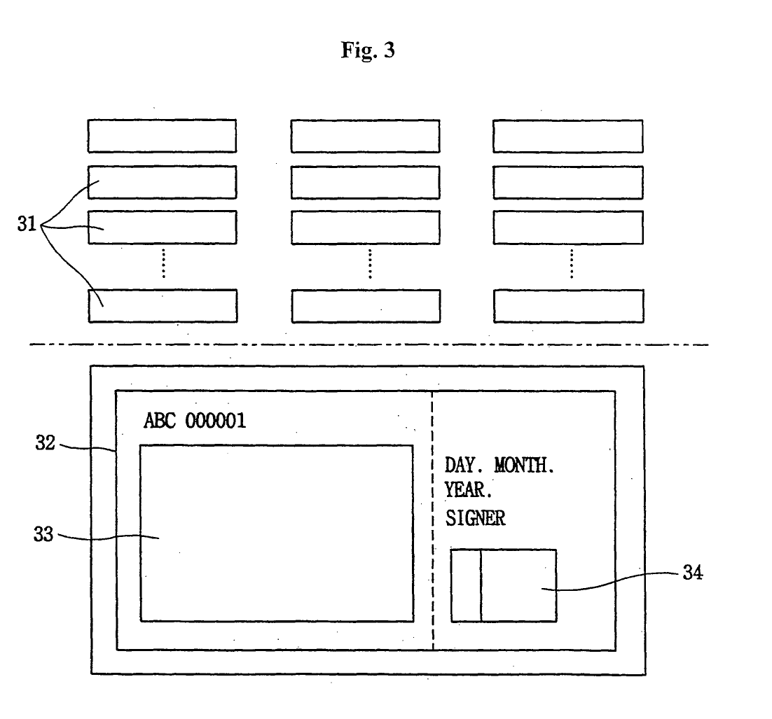

As described above, when the service user inputs the offer order information in the delivery information field and clicks “confirmation”, the client system transmits a message for requesting the order of the autograph as shown in FIG. 3 to the server system. The server system receives the offer order information, and transmits a new Web page for confirming the offer order information to the client system.

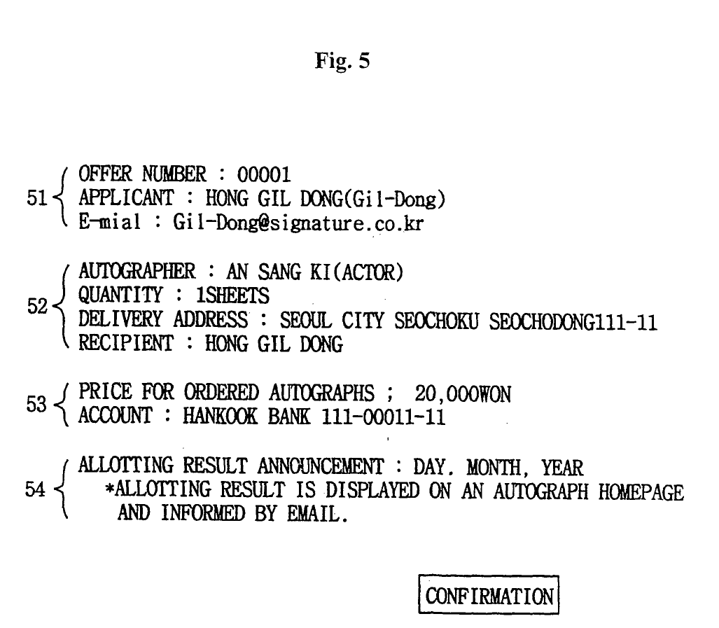

FIG. 5 is a view showing a screen for displaying the offer order information explanation obtained when the offer application is completed. As shown in FIG. 5, in the Web page for the offer order information, an applicant confirming field 51 for providing an offer number and information of the final offer applicant, an offer application confirming field 52 for providing information of the offer applied autograph, a receipts information field 53 for displaying an account of the service provider, and an offer guiding field 54 for informing allottees are sequentially displayed.

The offer applicant confirming field 52 is used for providing the service user with an opportunity of reviewing and altering the autograph offer order.

Further, in the receipts information field 53, a variety of payment means including credit card, electronic money or a cyber passbook can be used as well as the basic account of the service provider for online remittance.

As described above, the present invention provides a system and method for merchandising certified autographs via the Internet, in which service user connected to a Web server of a service provider via the Internet order autographs of existing famous persons on offer, and the service provider produces the ordered autographs to prevent forgery, charges a predetermined fee to the service users and thereafter delivers autographs to the service users, thereby enabling the worth and merchantability of the autographs, which are printed on fine printing paper, like a bill, to be derived, and assigning a monetary value to the autographs, thus utilizing the autographs as a personal gift or an object to be collected.

Further, the system and method of this invention is advantageous in that potential marketability by an issue of autographs is infinite due to the constant presence of famous persons or celebrities as the entertainment industry grows.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A, comprising:
1. A system for merchandising certified autographs via the Internet, comprising:
a client system (100) comprised of a web browser (101) for displaying various web pages, client identification information (102) such as a member ID, a password or the like, and Internet connection means; and
a server system (200) connected to the client system (100) via the Internet, and comprised of a plurality of web pages (201) including an autograph order form, a server engine (202) for selecting and transmitting appropriate web pages in response to hyper text transfer protocol information requested by the client system (100), a variety of information input forms (203) transferable in various formats when the client system (100) is connected to the server system (200) and then the client identification information (102) is requested by the client system (100), and a plurality of databases (204 to 207) for combining and retrieving various information processed by the drive of the server engine 202.

2. The system according to claim 1, wherein the databases (204 to 207) include:
a member information database (204) for storing basic member information of a service user and the client identification information (102), when the client system (100) accesses the server system (200) and transmits the client identification information (102);
an offer autograph database (205) for providing and storing autograph information which are on offer or are completed in offer, and are capable of being obtained through a variety of Web pages (201) transmitted to a Web browser (101) of the client system (100);
an offer applicant database (206) for storing client information that searches the offer autograph database (205) through the server system (200), and orders autographs offered in response to the searched information; and
a cooperative order database 207 for receiving cooperative offer orders from the client system (100) according to whether or not a corresponding autograph is registered, and storing the cooperative order information.

3. A method for merchandising certified autographs via the Internet, comprising the steps of:
a) operating a Web browser on a computer terminal by a service user, and accessing a Web server of a service provider by inputting URL information in response to hyper text transfer protocol (HTTP) information requested by the Web browser (S100);
b) transmitting identification information authenticated by a server system to a CGI program (S103);
c) displaying an offer application screen in which a plurality of offers for autographs and their information are summarized on the Web browser of each client system if the service user is authenticated (S105);
d) displaying autographer information selected from the offer application screen displayed on the Web browser of the service user by clicking a mouse (S106);
e) transmitting and displaying a variety of autograph forms to the Web browser of the client system by the server system when the autographer information is confirmed by the client system (S107);
f) generating a flag instruction for representing that the user is capable of ordering a selected autograph in response to client identification information by the server system, when the client system selects a desired autograph form from among the autograph forms, and requesting the client system to input regional delivery information by displaying a delivery information form among a plurality of information input forms (S108);
g) if the regional delivery information inputted in the delivery information form and the client identification information of the client system are transmitted to the server system to attempt to order an offer the autograph, receiving the client identification information again from the client system by the server system, and enabling the service user to confirm offer order details when the service user is finally identified as an offer applicant (S109); and
h) storing the offer order details displayed on the Web browser in an offer autograph database (S110).

4. The method according to claim 3, further comprising the steps of identifying the client identification information of a service user, which is inputted in a user's identification information field in the Web page displayed on the Web browser of the client system of the service user, and determining whether the user is signed up as a member by the server system when a homepage of the service provider is displayed (S101).

5. The method according to claim 3, further comprising the steps of:
inputting a member identification (ID) and a password of the service user in the information input form provided by the server system, and signing up as a member, when the client identification information is not authenticated (S103); and
storing basic member information of the user in a member information database of the server system if the service user is authenticated by the server system (S104).

6. A method for merchandising certified autographs via the Internet, comprising the steps of:
a) if a client system orders an offer for autographs, generating order information by integrating specific order information associated with the client system, such as an order for autograph offer, the order quantity of autographs, and a recipient by the server system, storing the order information of each client system in an offer applicant database, and allotting offered autographs in response to the offer applicant information (S200);
b) selecting client system information that selects a corresponding autograph as a first order from the offer applicant database when an offer allotting method is decided, and primarily designating the selected client system as a first allottee (S203);
c) displaying a list of first allottees on a Web site through the Web page of the server system, which is transmitted to the client system, and informing the allotting result to a corresponding client system by email (S204);
d) requiring the client system to pay for the offered autograph according to the quantity of autograph (S205); and
e) confirming payment of the client system through a computer network in the service provider's own database or banking facilities (S206).

7. The method according to claim 6, further comprising the step of allotting the offered autographs by lottery or order of arrival according to rules of the service provider (S201, S202).

8. The method according to claim 6, further comprising the steps of:
delivering the offered autograph to an autograph offer winner by mail service or predetermined delivering means in response to information obtained by combing and retrieving basic member information stored in the member information database of the server system and the specific offer order information stored in the offer applicant database, when the payment by the first allottee has confirmed (S207); and
allotting the offered autograph to a second order applicant as a second allottee if the payment by the first allottee is not confirmed for a predetermined period of time (S208).

9. A method for merchandising certified autographs via the Internet, comprising the steps of:
a) accessing a server system of a service provider by each client system of each service user, transmitting client identification information through a Web browser to the server system, and performing a login procedure (S300);
b) extracting a cooperative order application form selected among a plurality of Web pages and displaying the cooperative order application form on the Web browser of the client system, when the service user requires the server system to transmit a Web page for cooperative order (S301);
c) registering personal information provided from the client system or for providing the autographs designated by the server system by the service provider in the cooperative order application form (S302);
d) requesting the client system to describe the cooperative order application form (S303);
e) inputting each appropriate price and each order period for the cooperative ordered autograph in a predetermined cooperative order state window (S304); and
f) completing a cooperative order procedure through the above steps (S305).
